(19) United States
(12) Patent Application Publication
(10) Pub. No.: US 2007/0108104 A1
(43) Pub. Date: May 17, 2007

(54) Vibratory separators and operations

(76) Inventor: George Alexander Burnett, Aberdeen (GB)

Correspondence Address: Guy McClung, #114, 5315B F.M. 1960 Rd. West, Spring, TX, 77069-4410, US

(21) Appl. No.: 11/280,976

(22) Filed: Nov. 16, 2005

(51) Int. Cl. B03B 7/00; B07B 1/46; B07B 9/00

(52) U.S. Cl. 209/17; 209/243

(57) ABSTRACT

Improved upflow vibratory separators or shale shakers.

### BACKGROUND OF THE INVENTION

1. Field of the Invention

The present invention is directed to improvements to upflow shale shakers and to upflow vibratory separators, and to methods of their use.

2. Description of Related Art

Vibratory separators are used in a wide variety of industries to separate materials such as liquids from solids or solids from solids. Typically such separators have a basket or other screen holding or mounting apparatus mounted in or over a receiving receptacle or tank and vibrating apparatus for vibrating the basket. One or more screens is mounted in the basket. Material to be treated is introduced to the screen(s) either by flowing it directly onto the screen(s) or by flowing it into a container, tank, or “possum belly” from which it then flows to the screen(s). Also in some multi-screen apparatuses material flows generally horizontally or uphill from one screen to another and, in certain systems, from an upper screen onto a lower screen.

FIG. 1 illustrates an apparatus according to the prior art, in which the debris laden mud 1 flows downwardly through a vibrating flat screen 2 to filter out the debris. The screen 2 is vibrated by vibrating the whole body of the apparatus using motors 3 with eccentric weights, for example. The cleaned mud exits the apparatus and then generally is ready for re-use. Debris that does not pass through the screen is caught on the screen and is carried by the direction and amplitude of the screen vibration upwardly towards an exit 4. Corrugated shaped screens have been used in the industry. In certain prior art screens the mud passes either vertically down through the screen, as is the case with the flat screens, or has a downward component to the flow, as is the case with certain three-dimensional screens. Arrangements have been proposed where the angle of the screen is increased and may be vertical in parts.

Examples of the general configuration of filter are disclosed in U.S. Pat. No. 4,459,207, WO-A-02 43 832 and WO-A-03 028 907.

### SUMMARY OF THE INVENTION

In an upflow vibratory separator in which material to be treated flows up to a primary screen assembly in a box and fluid in the material flows up and through the primary screen assembly and solids in the material contact and do not flow through the primary screen assembly, the material flowing in and from a container, vibratory apparatus for vibrating the box and the primary screen assembly, at least part of the container disposed beneath the primary screen assembly, the improvement of a primary conveyor beneath the primary screen assembly for removing solids, the primary conveyor in one aspect having an auger inclined upwardly, and/or a deflector in the container for deflecting material away from the primary screen assembly.

The present invention, in certain aspects, discloses a vibratory separator system including a plurality of upflow vibratory separators, one adjacent the other, a common feed conduit for feeding material to be treated to the plurality of upflow vibratory separators, each upflow vibratory separator including a valve for selectively controlling the flow of the material thereto, each upflow vibratory separator an upflow vibratory separator according to the present invention.

To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a diagram illustrating a prior art screening apparatus.

FIG. 2 is a diagram illustrating various mud flow paths in apparatus according to the invention.

FIG. 3 is a diagrammatic end view of an apparatus according to one exemplary embodiment of the invention.

FIG. 4 is a side view of the apparatus of FIG. 3.

FIG. 5 illustrates an alternative embodiment of the invention.

FIG. 6 illustrates yet another embodiment of the invention.

FIG. 7A is a schematic side cross-section view of a system according to the present invention.

FIG. 7B is a cross-section view of part of the system of FIG. 7A.

FIG. 7C an end view of the system of FIG. 7A.

FIG. 8 is a schematic side cross-section view of a system according to the present invention.

FIG. 9A is a schematic side cross-section view of a system according to the present invention.

FIG. 9B is an end view of the system of FIG. 9A.

FIG. 9C is a cross-section view of the system of FIG. 9A.

FIG. 10A is a schematic side cross-section view of a system according to the present invention.

FIG. 10B is an end view of the system of FIG. 10A.

FIG. 11 is a top schematic view of a system according to the present invention.

### DESCRIPTION OF EMBODIMENTS PREFERRED AT THE TIME OF FILING FOR THIS PATENT

FIGS. 1-4 present subject matter which the present invention improves.

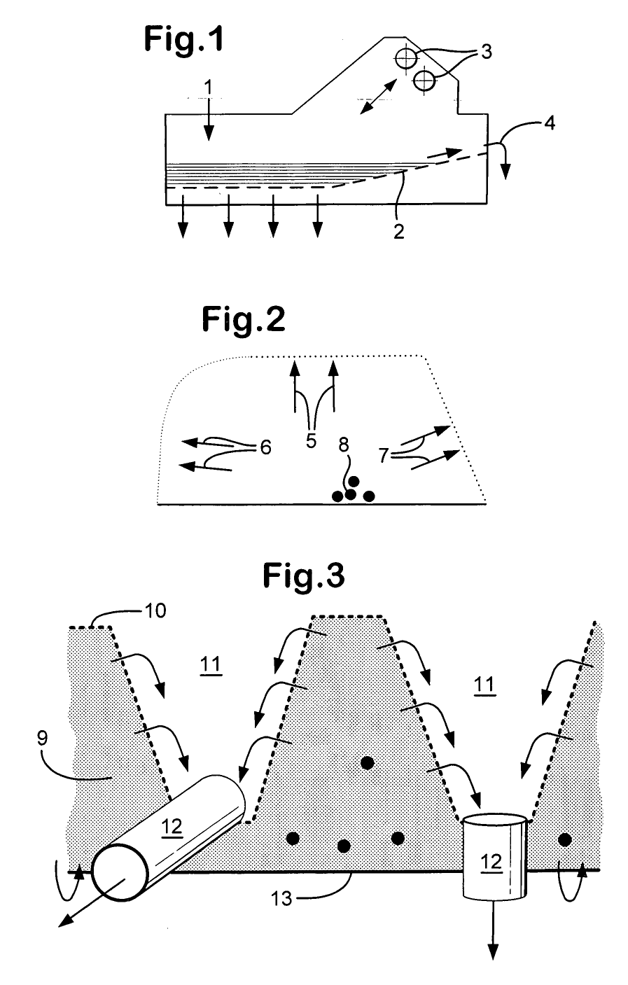

FIG. 2 shows new directions of flow for drilling fluid or mud with entrained debris. The mud passes through the screen either vertically 5, horizontally 6, or with an upward component 7. The debris falls under gravity to the lower surface 8 where it is conveyed out of the apparatus. The lower surface 8 may be a mesh screen, a roughened plate or a rotating belt or chain (s). The design of the apparatus is such that it is not possible for debris laden mud to bypass the screens. Unlike in certain prior art configurations, the mud is introduced into a compartment under the screens, not from above the screens. The pressure required to force the mud through the screen is provided by the height of a pool of mud adjacent to the screening compartment, although alternatively this could be provided for by other means such as a centrifugal pump.

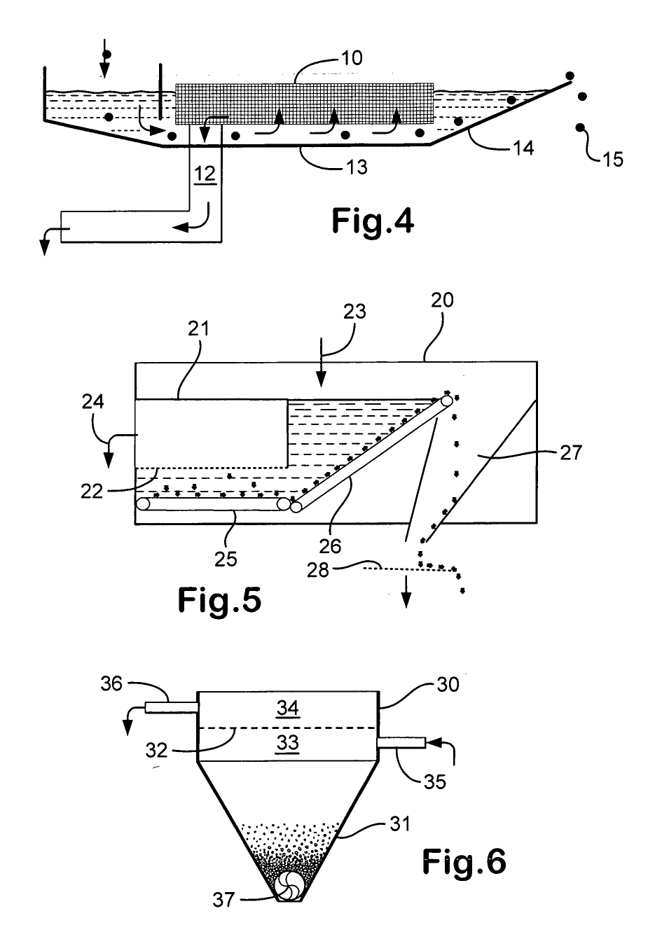

Referring now to FIGS. 3 and 4, debris-laden fluid or mud is introduced into a pool 9, and the fluid is forced through a vibrating screen 10 into a channel 11 that allows the substantially debris free mud to flow via pipe work or channels 12 to tanks for subsequent re-use. The cleaned mud may either exit the shakers from the sides or bottom of the shaker. The debris falls under gravity to a lower surface 13, which conveys the debris out from under the screen by vibration or via a moving belt. An inclined surface 14 conveys the debris out of the pool. This mode of conveyance may alternatively be a moving belt; however it is preferably similar to prior art inclined surfaces and consists of a vibrating screen which will assist the removal of mud from the debris. The debris 15 exiting the device may be sent to a screw press, centrifugal device or prior art shaker to further recover mud closely associated with the debris.

FIG. 5 shows an alternative arrangement, in which a main enclosure 20 contains a filter body 21 whose lowermost wall consists of a screen 22 which can be vibrated with the body 21 or independently thereof. In either case, the energy required to vibrate the screen is substantially smaller than would be required for vibration of the whole apparatus, as in the prior art apparatus. Debris-laden mud enters at 23 and the head of mud above the level of the screen 22 is sufficient to drive the mud through the screen into the body 21, from where it can flow out at 24 for re-use. Debris retained by the screen 22 is dislodged by the vibration and falls on to a horizontal conveyor belt 25, which carries it on to an inclined conveyor belt 26. This belt 26 carries the debris out of the mud and discharges it into a chute 27, from which it falls on to a secondary vibrating screen 28 arranged to remove residual mud for re-use before discharging the debris for disposal.

The embodiment of FIG. 6 has a filtration section 30 of uniform cross-section and a tapering section 31 beneath it. The filtration section 30 contains a vibrating screen 32 mounted so as to separate the filtration section into two sections: a lower inlet section 33 and an upper outlet section 34. The inlet section 33 is supplied with debris-laden mud via a supply pipe 35. The mud is pumped or otherwise supplied at a pressure sufficient to urge it upwardly through the vibrating screen 32 and into the outlet section 34, from where it flows for re-use through an outlet pipe 36.

Debris retained by the screen 32 falls into the tapering section 31, where it settles. An auger 37 is mounted in the lowermost part of the tapering section 31 and can be driven by an external motor (not shown) to urge the settled material out of the apparatus for disposal or further filtration or treatment as required to extract any residual liquid mud. In order to ensure that the minimum of liquid is removed in this manner, the tapering section 31 can be provided with a sensor to detect density or liquid content of the settled material above the auger 37 and to prevent operation of the external motor when the liquid content of the material adjacent to the auger is above a predetermined proportion, thereby preventing the loss of excess liquid mud.

It will be understood that, while the debris is represented in the drawings as discrete lumps or rock pieces, it will typically be a mixture of larger and smaller particles and pieces.

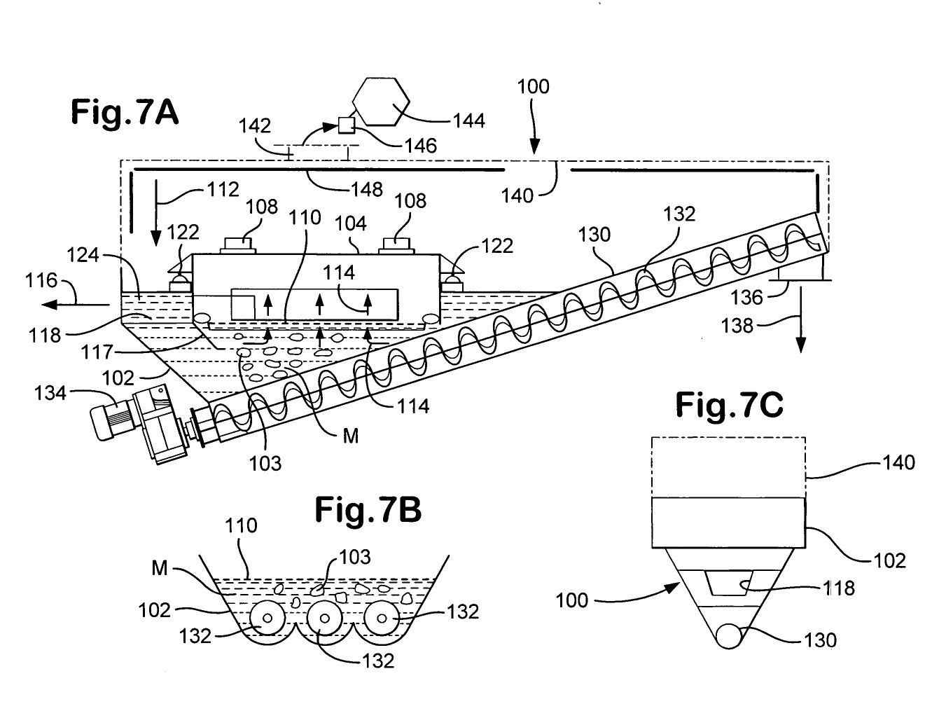

FIGS. 7A-7C illustrate a system 100 according to the present invention which has a housing 102 for containing material M to be treated. A screen apparatus 110 is removably secured to a box 104 which is mounted to the housing 102. Any known structure and/or apparatus may be used to removably secure the screen apparatus 110 to the box 104 and, as shown, in one aspect, a known inflatable seal apparatus 106 is used for this purpose.

Vibratory apparatus 108 connected to the box 104 vibrates the box 104 and thus the screen apparatus 110. Any suitable known vibratory apparatus may be used for the vibratory apparatus 108. Any suitable known screen or screens, screen assembly or screen assemblies may be used for the screen apparatus 110. The box 104 is mounted on anti-vibration mounts 122.

An arrow 112 indicates the introduction of the material M (including, but not limited to, drilling material including drilling fluid or mud, and drilled solids and debris) into the housing 102. Arrows 114 indicate the flow of the material M up to and through the screen apparatus 110. An arrow 116 indicates the discharge of recovered cleaned fluid 124 through a discharge duct 118 from the box 104 (shown schematically in FIG. 7C). In one aspect the duct 118 is flexible or has a flexible portion so that the duct 118 and the box 104 can be lowered in the housing 102, e.g. for access, maintenance, or cleaning. A deflector 117 directs incoming fluid flow. Heavier solids, directed by the deflector 117, will flow downwardly to the conveyor system 130 and will not impact the screen apparatus 110.

Solids S that do not pass through the screen apparatus 110 fall within the housing 102 and enter a conveyor system 130. An auger apparatus 132 rotated by a motor 134 augers the solids S up to a discharge opening 136. An arrow 138 indicates the flow of the material with discharged solids from the system 100 to storage, to disposal, or to additional processing.

According to the present invention, one, two, three, four, or more auger apparatuses may be used with a system according to the present invention; e.g. the system 100 as shown in FIG. 7B has three auger apparatuses 132. Optionally, the system 100 is enclosed with an enclosure 140. In one aspect air, fumes, gases, and/or material entrained in air above the box 104 are evacuated through an access opening 142. Optionally this is accomplished by an HVAC system 144 and/or a filtration system 146 with appropriate pumping apparatus and/or vacuum apparatus. Optionally the enclosure 140 itself or the enclosure 140 with sound insulation material 148 reduces noise from the system 100.

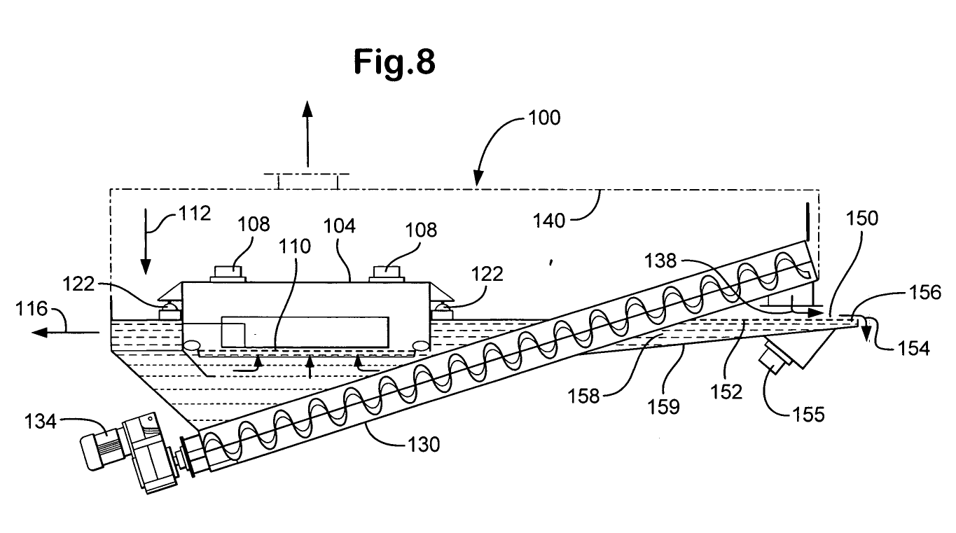

FIG. 8 illustrates one embodiment of the system 100 (and like numerals indicate like parts) which includes a screen apparatus 150 which receives the discharged material 138. It is within the scope of the present invention for the screen apparatus 150 to be inclined downwardly and for material to move off of it under the influence of gravity; or, as shown, in FIG. 8 the screen apparatus 150 includes vibratory apparatus 155 (like, e.g. the vibratory apparatus 108) which vibrates a screen or screens 152 (e.g. like the screen apparatus 110). Separated solids 154 flow off an exit end 156 of the screen(s) 152 and reclaimed fluid 158 flows to a receptacle or container 159.

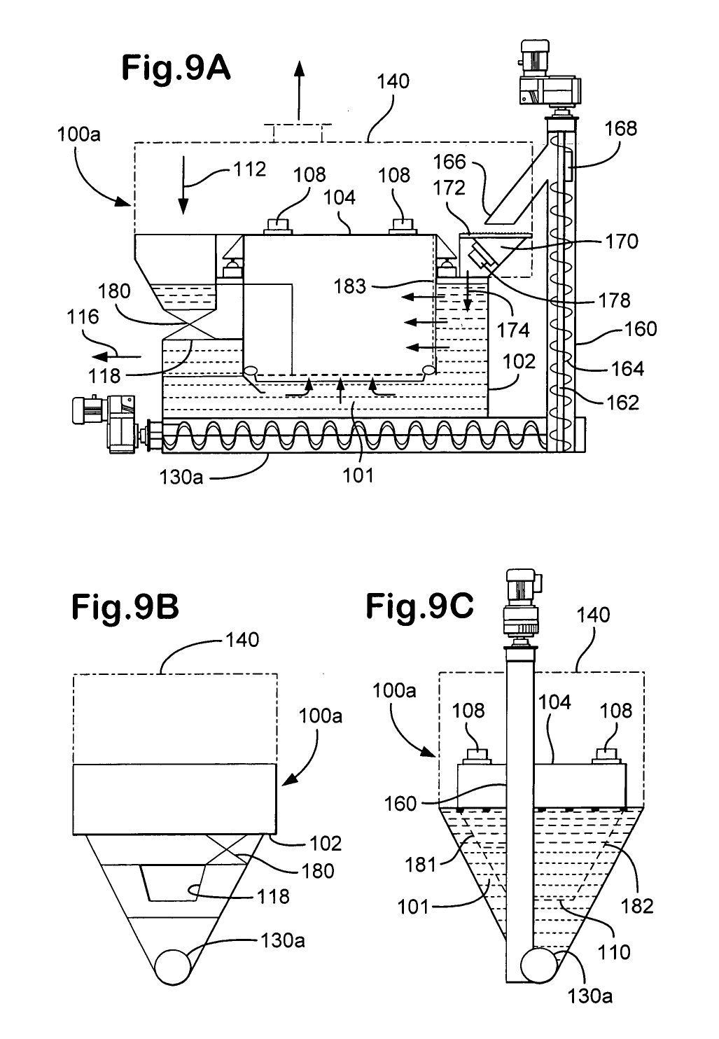

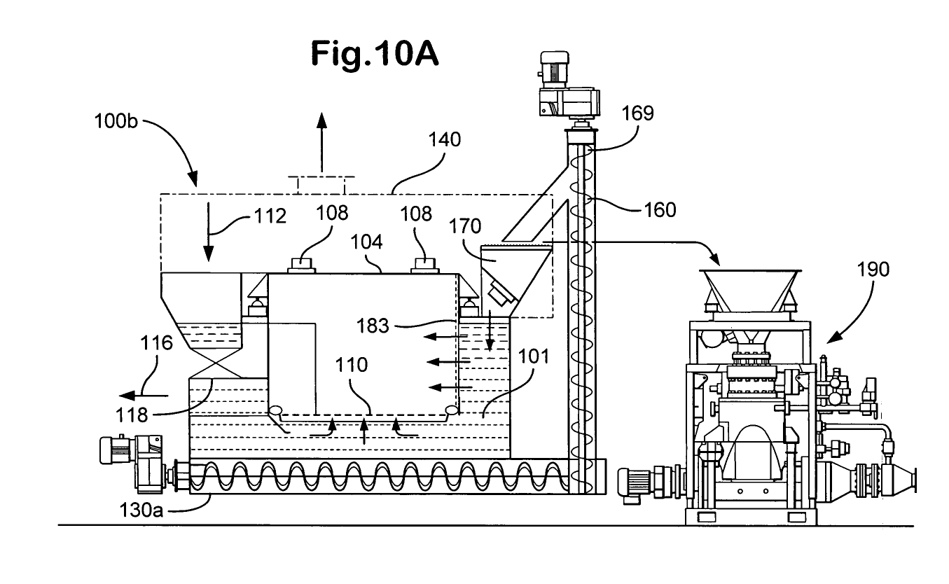

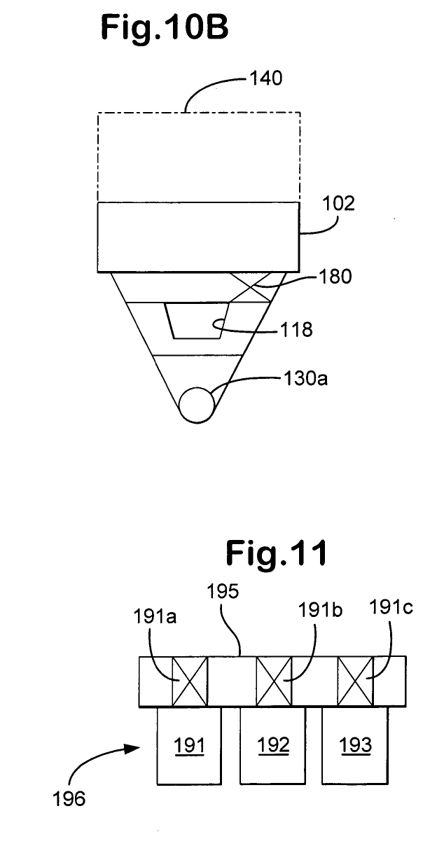

FIGS. 9A-9C illustrate an embodiment of a system 100 according to the present invention (like numerals indicate like parts) which includes at least one additional conveyor system 160 (like the conveyor system 130) which is oriented in a generally vertical orientation. A conveyor system 130a, like the system 130, may be oriented as shown in FIG. 7A or, as shown in FIG. 9A, may be oriented generally horizontally. The conveyor system 130a moves material with separated solids to the conveyor system 160 which, in turn, moves the material up to an exit duct 166. An optional paddle 168, secured to an auger apparatus 162 of the system 160 so that it is adjacent the duct 166, facilitates the movement of material into the exit duct 166. In one aspect the paddle 168 is a straight blade section on the auger apparatus 162 (as opposed to screw flights on the rest of the auger apparatus 162. Optionally, in one aspect a reversed flight 169 is used at the top of the auger apparatus (see, e.g. FIG. 10A) which moves material downwardly to the duct 166. Such a flight 169 can be used with the paddle 168.

Material with separated solids may, according to the present invention, flow to storage or to further processing or, as shown in FIG. 9A, may be introduced to a vibratory separator apparatus 170 with screening apparatus 172 (like the screening apparatus 110) vibrated by vibratory apparatus 178 (like the vibratory apparatus 108). It is within the scope of the present invention for the material with solids separated by the vibratory separator apparatus to flow to disposal, to storage, or to further processing. Reclaimed fluid from the vibratory separator apparatus 170 can be directed to storage or to a container; or, as shown in FIG. 9A by an arrow 174, it can flow back into the housing 102.

Optionally, a valve 180 selectively controls the flow of fluid into the housing 102. Optionally, in addition to (or instead of) the screen apparatus 110, one or more walls of the box 104 may have a screen mounted therein or thereon, or a screen or screens can be secured to the box 104. For example, as shown in FIG. 9C two inclined screens 181, 182 (like the screen apparatus 110) are secured to the box 104 and material M is flowable through the screens 181, 182 and through the screen apparatus 110. Additionally, and optionally, a further screen 183, oriented generally vertically, may be located to a vertical face 184 of the box 104.

In certain aspects, the use of an additional conveyor, such as the conveyor system 160, makes it possible for the material depth within the housing 102 to be increased as compared to a system with a lower conveyor system or systems. This can permit a screen apparatus to be set relatively deeper in a box which can result in side screens being taller so that more screening area is provided in a specified footprint area. In certain aspects according to the present invention, to empty a system as in FIG. 9A a height adjustment is made for both the box 104 and the duct 118.

FIG. 10A illustrates a system 100b like the system 100a of FIG. 9A (like numerals indicate like parts) which includes a solids conveying system 190. Solids separated by the vibratory separator apparatus 170 are introduced to the solids conveying system 190. In one particular aspect the solids introduced to the system 190 are drilled cuttings separated from a material that includes drilling fluid and drilled solids (“drilled cuttings”) and the system 190 is a drilled cuttings conveyance system. It is within the scope of the present invention to employ any suitable known cuttings conveyance system for the system 190.

As shown in FIG. 11 a system 196 according to the present invention may have a plurality of vibratory separators 191, 192, 193 (as any according to the present invention; in one aspect, each vibratory separator is a shale shaker processing drilling material). Material to be processed flows in a feed conduit or “gutter” 195 and each separator or shaker 191-193 has a flow valve 180a, 180b, 180c, respectively which selectively controls flow to each separator or shaker 191-193. Thus one, two or three separators or shakers 191-193 can be operational as desired. It is within the scope of the present invention to provide one, two, three, four, five, six or more separators or shakers in a system 196 according to the present invention.

The present invention, therefore, provides in certain, but not necessarily all embodiments,—in an upflow vibratory separator in which material to be treated flows up to a primary screen assembly in a box and fluid in the material flows up and through the primary screen assembly and solids in the material contact and do not flow through the primary screen assembly, the material flowing from a container to the primary screen assembly, vibratory apparatus for vibrating the box and the primary screen assembly, at least part of the container disposed beneath the primary screen assembly,—a material input for introducing the material into the container, a deflector adjacent the material input for directing material flowing through the material input away from the primary screen assembly. Any such separator may include one or some, in any possible combination, of the following with or without the deflector: a primary conveyor beneath the primary screen assembly for removing solids; locating conveyor means beneath the screen to carry the debris away from the screen; passing the separated debris through a further separation stage to remove entrained drilling fluid therefrom; conveyor means beneath the screen to carry the debris away from the screen; and/or separation means associated with the conveyor means for removing entrained mud from the debris; wherein the solids include liquid, the upflow vibratory separator further including separation apparatus for receiving solids conveyed by the primary conveyor, the separating apparatus for separating liquid from the solids; wherein the separation apparatus includes a secondary screen assembly for separating the solids from the liquid, the liquid flowing down through the secondary screen assembly; vibration apparatus for vibrating the secondary screen assembly; wherein the material is drilling material including drilling fluid and drilled solids; a secondary container for receiving and containing fumes from the material; evacuation apparatus for removing fumes from the secondary container; filtration apparatus for filtering fumes from the secondary container; the primary screen assembly mounted generally horizontally, and at least one tertiary screen assembly mounted non-horizontally for treating the material; wherein the at least one tertiary screen assembly is two spaced-apart tertiary screen assemblies, each extending upwardly from the primary screen assembly; a valve for controlling flow of material into the container; secondary conveyor for receiving the solids conveyed by the primary conveyor and for conveying the solids away from the primary conveyor, the solids including liquid; wherein the secondary conveyor has an exit through which solids including liquid exit for further processing; the secondary conveyor including auger apparatus for moving the solids including liquid to the exit; a paddle on the auger apparatus for moving solids including liquid to the exit; secondary vibratory separator apparatus for receiving solids including liquid from the exit of the secondary conveyor and for treating the solids including liquid, the secondary vibratory separator apparatus for producing separated solids and for producing liquid for introduction back into the container; solids conveying apparatus for receiving the solids from the secondary vibratory separator apparatus and for conveying the solids away from the upflow vibratory separator; and/or the primary conveyor including a plurality of spaced-apart auger apparatuses for moving the solids away from the upflow vibratory separator.

The present invention, therefore, provides in certain, but not necessarily all embodiments, a vibratory separator system including a plurality of upflow vibratory separators, one adjacent the other, a common feed conduit for feeding material to be treated to the plurality of upflow vibratory separators, each upflow vibratory separator including a valve for selectively controlling the flow of the material to a corresponding upflow vibratory separator, each upflow vibratory separator as any upflow vibratory separator according to the present invention.

The present invention, therefore, provides in certain, but not necessarily all embodiments, a method for treating material with an upflow vibratory separator, the upflow vibratory separator as any disclosed herein according to the present invention with conveyor apparatus, the method including flowing the material to the primary screen assembly and with the primary screen assembly filtering out solids from the material, the solids flowing downwardly in the container, and vibrating a screen or screen assembly with non-motorized vibration apparatus.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventor may rely on the Doctrine of Equivalents to determine and assess the scope of their invention and of the claims that follow as they may pertain to apparatus not materially departing from, but outside of, the literal scope of the invention as set forth in the following claims. Any patent or patent application referred to herein is incorporated fully herein for all purposes.

What is claimed is:

1. In an upflow vibratory separator in which material to be treated flows up to a primary screen assembly in a box and fluid in the material flows up and through the primary screen assembly and solids in the material contact and do not flow through the primary screen assembly, the material flowing from a container to the primary screen assembly, vibratory apparatus for vibrating the box and the primary screen assembly, at least part of the container disposed beneath the primary screen assembly, the improvement comprising
a material input for introducing the material into the container, and
a deflector adjacent the material input for directing material flowing through the material input away from the primary screen assembly.

2. The upflow vibratory separator of claim 1 further comprising
primary conveyor means beneath the primary screen assembly for removing solids that do not pass through the primary screen assembly.

3. The upflow vibratory separator of claim 2 wherein the solids include liquid, the upflow vibratory separator further comprising
separation means for receiving solids conveyed by the primary conveyor means, the separating means for separating liquid from the solids.

4. The upflow vibratory separator of claim 3 wherein the separation means includes a secondary screen assembly for separating the solids from the liquid, the liquid flowing down through the secondary screen assembly.

5. The upflow vibratory separator of claim 4 further comprising
vibration apparatus for vibrating the secondary screen assembly.

6. The upflow vibratory separator of claim 1 wherein the material is drilling material including drilling fluid and drilled solids.

7. The upflow vibratory separator of claim 1 further comprising
a secondary container above the box for receiving and containing fumes from the material.

8. The upflow vibratory separator of claim 7 further comprising
evacuation apparatus for removing fumes from the secondary container.

9. The upflow vibratory separator of claim 8 further comprising
filtration apparatus for filtering fumes from the secondary container.

10. The upflow vibratory separator of claim 1 further comprising
the primary screen assembly mounted generally horizontally, and
at least one tertiary screen assembly mounted non-horizontally for treating the material.

11. The upflow vibratory separator of claim 10 wherein the at least one tertiary screen assembly is two spaced-apart tertiary screen assemblies, each extending upwardly from the primary screen assembly.

12. The upflow vibratory separator of claim 1 further comprising
a valve for controlling flow of material into the container.

13. The upflow vibratory separator of claim 2 further comprising
secondary conveyor means for receiving the solids conveyed by the primary conveyor means and for conveying the solids away from the primary conveyor means, the solids including liquid.

14. The upflow vibratory separator of claim 13 wherein the secondary conveyor means has an exit through which solids including liquid exit for further processing.

15. The upflow vibratory separator of claim 14 further comprising
the secondary conveyor means including auger apparatus for moving the solids including liquid to the exit.

16. The upflow vibratory separator of claim 15 further comprising
a paddle on the auger apparatus for moving solids including liquid to the exit.

17. The upflow vibratory separator of claim 14 further comprising
secondary vibratory separator apparatus for receiving solids including liquid from the exit of the secondary conveyor means and for treating the solids including liquid, the secondary vibratory separator apparatus for producing separated solids and for producing liquid for introduction back into the container.

18. The upflow vibratory separator of claim 17 further comprising
solids conveying apparatus for receiving the solids from the secondary vibratory separator apparatus and for conveying the solids away from the upflow vibratory separator.

19. The upflow vibratory separator of claim 17 further comprising
the primary conveyor means including a plurality of spaced-apart auger apparatuses for moving the solids away from the upflow vibratory separator.

20. A vibratory separator system comprising
a plurality of upflow vibratory separators, one adjacent the other,
a common feed conduit for feeding material to be treated to the plurality of upflow vibratory separators,
each upflow vibratory separator including a valve for selectively controlling the flow of the material thereto,
each upflow vibratory separator as the upflow vibratory separator of claim 1, 2, 3, 4, 5, 6, 7, 8, 9, 10, 11, 12, 13, 14, 15, 16, 17, 18, or 19.

21. In a method of removing debris from drilling fluid, comprising passing the fluid through a vibrating screen which lies in a plane which is not vertical so that one face of the screen is directed generally downwardly and the opposite face is directed generally upwardly, characterized by passing the fluid through the screen from the side of the screen having the generally downwardly directed face through to the side having the generally upwardly directed face, the improvement comprising
locating conveyor means beneath the screen to carry the debris away from the screen, the conveyor means including an auger inclined upwardly.

22. In an apparatus for removing debris from drilling fluid, comprising a vibrating screen which lies in a plane which is not vertical so that one face of the screen is directed generally downwardly and the opposite face is directed generally upwardly, and means for introducing the fluid to the screen such that the fluid passes through the screen from the side of the screen having the generally downwardly directed face through to the side having the generally upwardly directed face, the improvement comprising
conveyor means beneath the screen to carry the debris away from the screen, the conveyor means including an auger inclined upwardly.

23. In an apparatus for removing debris from drilling fluid, comprising a vibrating screen which lies in a plane which is not vertical so that one face of the screen is directed generally downwardly and the opposite face is directed generally upwardly, and means for introducing the fluid to the screen such that the fluid passes through the screen from the side of the screen having the generally downwardly directed face through to the side having the generally upwardly directed face, the improvement comprising
a deflector adjacent the screen for deflecting debris away from the screen.

24. A method for treating material with an upflow vibratory separator, the upflow vibratory separator comprising primary conveyor beneath a primary screen assembly in a box for removing solids that do not pass through the primary screen assembly, the upflow vibratory separator an upflow vibratory separator in which material to be treated flows up to the primary screen assembly and fluid in the material flows up and through the primary screen assembly and solids in the material contact and do not flow through the primary screen assembly, the material flowing from a container to the primary screen assembly, vibratory apparatus for vibrating the box and the primary screen assembly, at least part of the container disposed beneath the primary screen assembly, a deflector adjacent the primary screen assembly for deflecting material away from the primary screen assembly, the method comprising
flowing the material to the primary screen assembly and with the primary screen assembly filtering out solids from the material, the solids flowing downwardly in the container, and
deflecting material with the deflector away from the primary screen assembly.
